(19) United States
(12) Patent Application Publication
(10) Pub. No.: US 2005/0164009 A1
(43) Pub. Date: Jul. 28, 2005

(54) Polymer surface with increased hydrophilicity and method of making

(76) Inventor: Peter C. Rieke, Pasco, WA (US)

Correspondence Address: Battelle Memorial Institute;IP Services, (K1-53), P.O. Box 999, Richland, WA, 99352, US

(21) Appl. No.: 10/764,223

(22) Filed: Jan. 22, 2004

(51) Int. Cl. B32B 27/16; B32B 27/32; B32B 33/00; B05D 3/00; B32B 27/30

(52) U.S. Cl. 428/421; 428/422; 428/522; 428/523; 428/702; 427/532

(57) ABSTRACT

A polymer having a surface with increased hydrophilicity comprises a functionalized surface with a modified water contact angle less than the contact angle characteristic of an as-received, non-functionalized polymer surface. A method for making the hydrophilic polymer having the functionalized surface comprises exposing the non-functionalized surface to a plasma and a reactive gas.

### GOVERNMENT LICENSE CLAUSE

This invention was made with Government support under Contract DE-AC0676RL01830 awarded by the U.S. Department of Energy. The Government has certain rights in the invention.

### FIELD OF INVENTION

The present invention relates to the field of chemical surface treatments and, more particularly, to polymers having at least one modified surface for increased hydrophilicity and a method of making same.

### BACKGROUND OF THE INVENTION

Hydrophilicity describes a general property of a material surface associated with high wettability and liquid or aqueous adhesion. While many polymers are light weight, strong, and have high chemical resistance, they are typically not hydrophilic and hinder formation of a continuous film or coating on a surface of the polymer. Examples of non-hydrophilic, also known as hydrophobic, polymers include polypropylene, polyethylene, polystyrene, and fluoro-polymers (e.g., polyvinyledinedifluoride, polytetrafluoroethylene, etc.). Accordingly, hydrophobic polymers are not ideal for use in many applications requiring a surface having a high affinity for water. For example, hydrophobic polymers have limited efficacy as a packing material in separation columns used for mass transport processes.

Packing materials cause a liquid stream to spread over a large surface area to improve mass transfer between the liquid stream and a gas phase during: (1) distillation, where compounds are separated by condensation temperature, (2) absorption, where compounds are removed from the gas phase into the liquid stream, and (3) stripping, where volatile compounds are removed from the liquid stream into the gas phase. Three basic types of packing material currently exist—metal, ceramic, and plastic. Generally, ceramic packing materials have the advantage of being highly hydrophilic and structurally, thermally, and chemically durable. However, ceramic materials are dense, heavy, and difficult to form into high surface area shapes. Additionally, the weight of ceramic packing materials requires a stronger, more expensive vessel or column and tends to crush elements near the bottom of the column. High surface area designs are more fragile and exacerbate the crushing problem. Structurally stronger and simpler shapes result in greater flow resistance, which requires larger fans or gas pumps to move gas through the column. Simpler shapes also have a lower surface area to volume ratio and require greater volumes to achieve the desired surface area.

Metal packings are structurally stronger and are more easily formed into a given shape than ceramics. However, while metal packings provide many of the same advantages as their ceramic counterparts, they are not chemically compatible with many aqueous-based separation processes, especially those involving acidic gasses.

Polymer packing materials are advantageous because they are lightweight and easily formed into complex, three-dimensional, open or wireframe-type shapes that provide more surface area per unit mass or volume. One example of a high surface area polymer packing material is the Q-PAC product available from Lantec Products, Inc. in Agoura Hills, Calif. Similar wireframe-type polymer packings are produced by Koch-Glitsch and Jager, Inc. However, because plastic is much less hydrophilic than ceramic, the aqueous phase tends to flow in rivulets rather than forming uniform films, which maximizes the available surface area. Therefore, to achieve the desired mass transfer, columns filled with conventional polymer packing materials must have relatively larger volumes resulting in increased costs.

Several methods exist to chemically treat polymer surfaces for increased hydrophilicity. However, many of these methods are not effective for the previously-mentioned hydrophobic polymers. For example, mere liquid- or gas-phase chemical reactions are not highly effective at increasing the wettability of certain highly-chemically inert polymers such as polyethylene, polypropylene, and the halogenated analogues of these basic polymers. Moreover, many methods described in the art suffer from one or more of the following disadvantages:

(1) low throwing power, which describes the ability of a particular surface treatment process to conformally affect irregularly shaped features on a surface and restricts the use of such a treatment process to polymer surfaces having relatively simple geometries and a direct line of sight to the treatment source;

(2) lack of a treatment step that provides a polymer surface primed to receive a subsequently deposited metal oxide coating; and

(3) greater manufacturing costs associated with the purchase and maintenance of equipment required for large-scale production under vacuum conditions.

Thus, a need exists for a polymer having a surface with a greater hydrophilicity and a method of making same.

### SUMMARY

In view of the foregoing and other problems, disadvantages, and drawbacks of polymers with hydrophobic surfaces, the present invention has been devised. The invention includes: (1) a polymer having a functionalized surface of greater hydrophilicity than an as-received, nonfunctionalized polymer surface; and (2) a method of making the same. The method for obtaining the functionalized surface with chemical functional groups attached thereto and with greater hydrophilicity comprises the steps of providing a polymer having a nonfunctionalized surface and exposing the nonfunctionalized surface to a plasma and a reactive gas. The polymer material having a surface with increased hydrophilicity comprises a functionalized surface with a modified water contact angle less than the contact angle characteristic of an as-received, nonfunctionalized polymer surface.

One object of the present invention is to provide a modified polymer packing material with increased hydrophilicity compared to an unmodified column packing material. The modified polymer packing material comprises a plurality of surfaces that have been functionalized by exposure to a plasma and a reactive gas. The functionalized, polymer packing material has greater column efficiency compared with typical, nonfuctionalized polymer packing material.

Another object of the present invention is to provide a method of increasing the hydrophilicity of a polymer surface, especially polyethylene, polypropylene, and their derivitives, comprising the steps of providing a polymer having a non-functionalized surface, exposing the non-functionalized surface to a plasma and a reactive gas, and obtaining a functionalized polymer surface.

Yet another object of the present invention is to provide a method of increasing the surface hydrophilicity of conventional contact lenses, biological implants, and other polymers having non-planar structures and complex, three-dimensional shapes.

The subject matter of the present invention is particularly pointed out and distinctly claimed herein. However, both the organization and method of operation, together with further advantages and objects thereof, may best be understood by reference to the following description taken in connection with accompanying drawings wherein like reference characters refer to like elements.

### DESCRIPTION OF THE DRAWINGS

FIG. 1 is an illustration showing an isometric view of the complex, three-dimensional polymer packing material.

FIG. 2 is a schematic diagram of a scrubbing column.

FIG. 3a is a graph plotting the number of transfer units (NTUS) versus the water flow rate for columns filled with functionalized or as-received polymer packing materials.

FIG. 3b is a graph plotting the NTUs versus water flow rate for columns filled with functionalized or as-received polymer packing materials.

### DETAILED DESCRIPTION

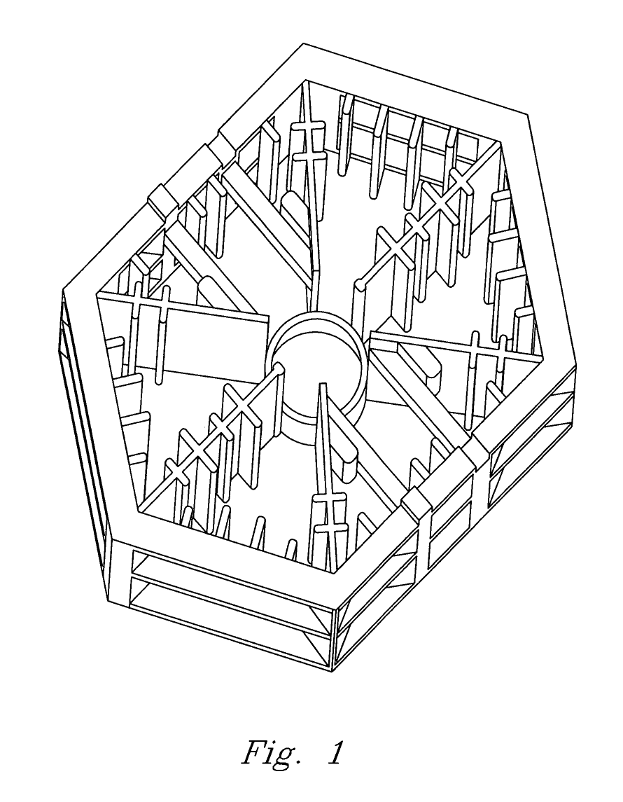

A polymer having a non-functionalized surface can be enhanced by exposure to a plasma and a reactive gas to produce a functionalized surface with increased hydrophilicity. The shape of the polymers may range from simple and non-planar structures, as in contact lenses, to complex, three-dimensional, or wire structures, as in polymer separation-column packing materials. FIG. 1 shows an example of a packing-material geometry with a plurality of surfaces that may be treated by the instant invention.

Polymers that may benefit from the instant invention include polycarbonate, polystyrene, acrylic polymers, polypropylene, polyethylene, and halogenated polymers, including the halogenated analogues of polypropylene and polyethylene. Some examples of halogenated polymers include poly-n-fluoroethylene (e.g., Teflon), poly-n-fluoropropylene, polyvinylidenedifluoride (e.g., Kynar), polyvinylchloride, and combinations thereof, wherein n is an integer selected from the group of mono, di, tri, and tetra.

In one embodiment, exposure of the polymer surface to the plasma and the reactive gas can be substantially simultaneous, in which the plasma and reactive gas are concurrently present with the polymer. In another embodiment, the exposure can be sequential, in which the plasma exposure precedes the reactive gas exposure. In one version of the invention, the exposures occur in the chamber of a plasma unit modified to incorporate an inlet for the reactive gas. The inlet may be separate from, or connected to, the plasma inlet and may comprise a valve and tube connecting the reactive gas to the plasma chamber. The reactive gas functionalizes the polymer surface by attaching chemical functional groups thereon. The plasma enhances the reactivity of the polymer surface to the reactive gas (or liquid) such that the combination ultimately results in increased surface hydrophilicity.

The plasma is at least partially comprised of a gas selected from the group of gases consisting of oxygen, nitrogen, nitrous oxide, air, the noble gases, and combinations thereof. Preferably, the plasma would contain oxygen. The reactive gas is at least partially comprised of a gas selected from the group consisting of oxides, halides, hydrazines, arsine, and combinations thereof. Examples of oxide gases include SOₓ, COₓ, NOₓ, ClO₂, BrO₂, IO₂, and HCLO₂. Preferably, the reactive gas is SO₃ or fuming sulfuric acid vapors. Examples of halide gases include Cl₂, Br₂, and I₂.

In one version of the invention, the chemical functional group may be an acidic functional group including, but not limited to a sulfonate, a phosphate, a carboxylate, or combinations thereof, In another version, the chemical functional group may be a basic functional group including, but not limited to an amine, a hydroxyl, or combinations thereof. In yet another version, the chemical functional group may be a neutral functional group including, but not limited to an alcohol, a thiol, or combinations thereof. As described earlier, exposing the polymer surface to the plasma and the reactive gas results in a functionalized polymer surface.

One of ordinary skill in the art will appreciate that the functionalized surface may be washed with water or an alternative solvent to remove any reactive gas residue. The solvent should be selected based upon the solubility of the given residue.

The functionalized polymer surface may be immersed in a liquid-phase reactant which can be heated, to induce the growth of a metal oxide layer. Preferably, the liquid-phase reactant comprises metal alkyls, metalorganics, metal oxide solutions, and combinations thereof. The metal oxide layer is preferably comprised of an iron oxide and is beneficial for further increasing the surface wettability and enhancing the mechanical and chemical durability. Following metal oxide growth, the surface may further be treated with a NaOH solution and then rinsed. The NaOH treatment improves the wettability by presumably rehydrating the metal oxide surface.

Hereafter, the present invention is described in more detail by referring to the Examples.

### EXAMPLE 1

FIG. 1 illustrates a polymer geometry that may be treated using the instant invention. FIG. 1 also serves as a specific, but non-limiting, example of a polymer packing. In this example, an experiment was conducted according to the present invention to demonstrate surface modification of two-inch polypropylene packing material, wherein the packing material is first treated with an air plasma in a small commercial plasma unit. The plasma-treated packing material was then exposed under vacuum to sulfur trioxide vapors given off by heated fuming sulfuric acid. The polypropylene packing material was then placed in a solution containing 3 millimolar Fe(NO₃)₃ and 11 millimolar nitric acid (approximately pH 2) and heated to 70° C. until a dark, rust-brown film formed on the polypropylene surfaces, indicating successful iron oxide deposition.

### EXAMPLE 2

A control experiment was conducted to characterize the hydrophilicity of a polymer surface under conditions of: (1) as-received, (2) oxygen plasma treated, and (3) SO₃-gas sulfonated. The experimental results from the control experiment were compared to the hydrophilicity of a polymer surface under conditions of the present invention of: (4) plasma sulfonated (plasma treatment followed by sulfonation), and (5) plasma sulfonated followed by iron oxide overlayer growth. The conditions under which the experiments were conducted are summarized:

(1) As-Received

Small coupons of polypropylene (PP) and polyvinylidenedifluoride (PVDF) were rinsed in methanol to remove surface residue and then air dried. The contact angles were measured using a Rame-Hart contact angle goniometer and the average of three measurements was calculated.

(2) Oxygen Plasma Treated

Samples prepared as in (1) were then treated in an oxygen-containing (air) plasma using a low-power, laboratory-scale, cleaning plasma for approximately 10 minutes.

(3) Gas-Phase Sulfonated

Samples prepared as in (1) were additionally treated for 10-20 minutes in the SO₃ vapors rising from liquid SO₃.

(4) Oxygen Plasma followed by SO₃ Gas Sulfonation

Samples prepared as in (1) were further treated in an oxygen-containing (air) plasma using a low-power, laboratory-scale, cleaning plasma for approximately 10 minutes. The samples were removed and then placed in a closed container along with several milliliters of fresh fuming sulfuric acid. The samples were then exposed to the SO₃ fumes rising from the liquid for 10 minutes, but were not allowed to directly contact the liquid. Finally, the samples were rinsed in clean water and blown dry.

(5) Concurrent Oxygen and SO₃ Gas Plasma

Samples prepared as in (1) were further treated by a combined gas of air and SO₃ vapor. The SO₃ was introduced to the plasma chamber through a glass valve connected to a container of liquid SO₃. The plasma was ignited for 15 minutes.

The contact angle for FeOOH films prepared on silicon wafers was measured as an additional control experiment. The initial contact angle for the film was approximately 100°. This value was much higher than expected and was considered to be caused by dehydration of the FeOOH surface. After brief treatment with 0.5 M NaOH, which rehydrated the surface, and subsequent rinsing, the water contact angle was reduced to an average value of 23°. The iron oxide films were sufficiently thick that the influence of the substrate material on the contact angle was negligible. The results are summarized in Table 1.

TABLE 1
Summary of the contact angles measured for coupons of polypropylene
(PP) and polyvinylidenedifluoride (PVDF) after various surface
modification. Contact angle results for the FeOOH film on Si are
also included.

| Surface | | | | | | |
|---|---|---|---|---|---|---|
| Treatment | Polymer | Trial 1 | Trial 2 | Trial 3 | Trial 4 | Average |
| As-received | PP | 96° | 98° | 94° | — | 96° |
| | PVDF | 84° | 86° | 86° | — | 85° |
| O₂ plasma | PP | 52° | 42° | 48° | — | 47° |
| only | PVDF | 51° | 41° | 62° | 55° | 52° |
| SO₃ gas | PP | — | — | — | — | — |
| only | PVDF | 61° | 60° | 63° | 66° | 63° |
| O₂ plasma | PP | 0° | 0° | 0° | 0° | 0° |
| then SO₃ | PVDF | 42° | 43° | 41° | 42° | 42° |
| Air and SO₃ | PP | — | — | — | — | — |
| plasma | PVDF | 44° | 48° | 49° | 55° | 49° |
| FeOOH on | n/a | n/a | n/a | n/a | n/a | 23° |
| silicon | | | | | | |
| wafer | | | | | | |

### EXAMPLE 3

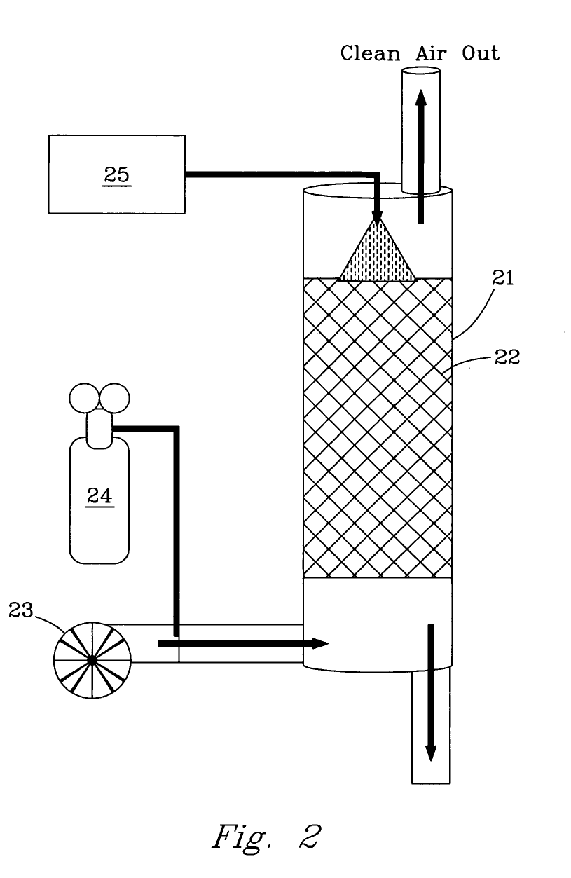

Another experiment compared column operation when using as-received polypropylene packings to column operation when using the surface-functionalized packing material described in Example 1. Referring to FIG. 2, a simple column 21 was constructed from plexiglass that had an active area of 1 ft.×1 ft. and a height of 5 ft. The column was filled 22 with either the surface-functionalized packing material from Example 1 or the as-received polypropylene material. Air was blown into the bottom of the column using an electric fan 23. Ammonia (NH₃) 24, was added to the air stream, flowed through the column 21, and exhausted into a laboratory hood. Water 25 was sprayed over the top of the column and allowed to percolate through the packing material 22 and out of the column. Although the experimental configuration would not allow the air flow rate to be varied, the ammonia inlet concentration and the water flow rate were varied. The ammonia concentration was measured at the inlet and outlet streams by drawing an aliquot of air through a tube containing an indicator sensitive to ammonia concentration.

The experimental results are expressed in terms of the number of transfer units (NTUs). The NTU value can be used to quantitatively compare the as-received and surface-functionalized packing materials. The NTU value can also be used to calculate the efficiency of a particular column design. In general, for a given column area and set of operating conditions, the height necessary to achieve a desired analyte concentration in the output stream is inversely proportional to the number of NTUs.

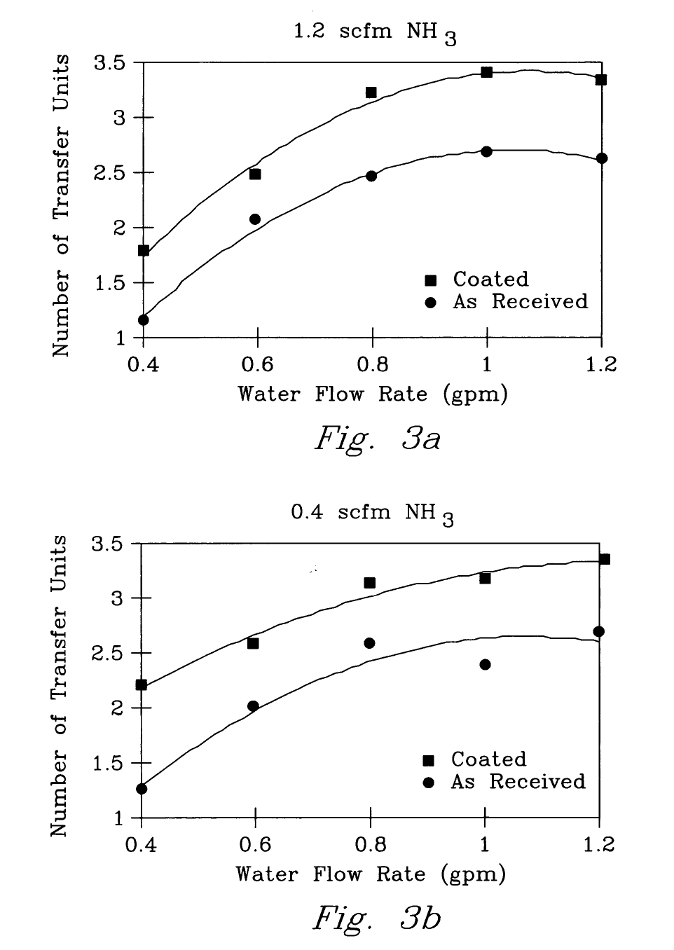

The NTU for the laboratory-scale column was determined for a variety of water flow rates and input ammonia concentrations. FIGS. 3a and 3b show results for ammonia flow rates of 1.2 standard cubic feet per minute (SCFM) and 0.4 SCFM, respectively. The data points are fitted with a second order polynomial line to emphasize the general trend. For both the surface-functionalized and as-received polymer packing material, the efficiency of the column increased with increasing water flow rates up to a maximum value. The NTUs did not strongly depend on the flow of ammonia gas, suggesting that considerably higher flow rates of ammonia could be tolerated before the efficiency would be negatively affected.

Most significantly, the NITUs were substantially greater for the surface-functionalized polymer packing material than for the as-received packing material. At the lowest water flow rates, the functionalized packing material is almost twice as efficient as the as-received packing. The improved performance of the functionalized packing is attributed to the enhanced wettability of the surface, which is a direct result of the surface functionalization of the present invention.

While a preferred embodiment of the present invention has been shown and described, it will be apparent to those skilled in the art that many changes and modifications may be made without departing from the invention in its broader aspects. The appended claims, therefore, are intended to cover all such changes and modifications as they fall within the true spirit and scope of the invention.

1. A method of increasing the hydrophilicity of a polymer surface, comprising the steps of:
a. providing a polymer having a nonfunctionalized surface;
b. exposing said nonfunctionalized surface to a plasma; and
c. exposing said nonfunctionalized surface to a reactive gas;
whereby a functionalized polymer surface with increased hydrophilicity is obtained.

2. The method as recited in claim 1, wherein step b and step c occur substantially simultaneously.

3. The method as recited in claim 1, wherein step b occurs before step c.

4. The method as recited in claim 1, wherein said polymer is a poly-halogenated polymer.

5. The method as recited in claim 4, wherein said poly-halogenated polymer is selected from the group consisting of poly-n-fluoroethylene, poly-n-fluoropropylene, polyvinylidenedifluoride, polyvinylchloride, and combinations thereof.

6. The method as recited in claim 5, wherein n is selected from the group consisting of mono, di, tri, and tetra.

7. The method as recited in claim 1, wherein said polymer is polypropylene or polyethylene.

8. The method as recited in claim 1, wherein said polymer comprises polystyrene, polycarbonate, and acrylic polymers.

9. The method as recited in claim 1, wherein said plasma is selected from the group consisting of O₂, N₂, N₂O, air, the noble gases, and combinations thereof.

10. The method as recited in claim 1, wherein said reactive gas is selected from the group consisting of oxide, halide, hydrazine, arsine, and combinations thereof.

11. The method as recited in claim 10, wherein said oxide comprises SOₓ, COₓ, NOₓ, halogen oxide, and combinations thereof.

12. The method as recited in claim 11, wherein said halogen oxide is selected from the group consisting of ClO₂, BrO₂, IO₂, HClO₂, and combinations thereof.

13. The method as recited in claim 10, wherein said oxide is selected from the group consisting of SO₃, SO₂, CO₂, NO, NO₂, and combinations thereof.

14. The method as recited in claim 10, wherein said halide is selected from the group consisting of Cl₂, Br₂, I₂, and combinations thereof.

15. The method as recited in claim 1, further comprising the step of washing said functionalized polymer surface with a solvent thereby removing a residue from said reactive gas.

16. The method as recited in claim 15, wherein said solvent comprises water.

17. The method as recited-in claim 1, further comprising the steps of exposing said functionalized polymer surface to a liquid-phase reactant and heating said liquid-phase reactant to induce growth of a metal oxide on said functionalized polymer surface.

18. The method as recited in claim 17, wherein said liquid-phase reactant is selected from the group consisting of metal alkyls, metal organics, metal oxide solutions, and combinations thereof.

19. The method as recited in claim 17, further comprising the step of treating the functionalized polymer surface with a NaOH solution after growth of said metal oxide.

20. The method as recited in claim 1, wherein said polymer comprises non-planar shapes.

21. The method as recited in claim 20, wherein said non-planar shapes comprise complex, three-dimensional geometries.

22. The method as recited in claim 21, wherein said complex, three-dimensional geometries are polymer packing materials, contact lenses, or biological implants.

23. The method as recited in claim 1, wherein said functionalized polymer surface comprises said nonfunctionalized polymer surface with functional groups selected from the group consisting of acidic, basic, and neutral functional groups attached thereon.

24. The method as recited in claim 23, wherein said acidic functional group is selected from the group consisting of sulfonate, phosphate, carboxylate, and combinations thereof.

25. The method as recited in claim 23, wherein said basic functional group is selected from the group consisting of amine, hydroxyl, and combinations thereof.

26. The method as recited in claim 23, wherein said neutral functional group is selected from the group consisting of alcohol, thiol, and combinations thereof.

27. A polymer having a surface treated in accordance with the process of claim 1.

28. A polymer packing material with increased hydrophilicity comprising a plurality of surfaces, said plurality of surfaces functionalized by exposure to a plasma and to a reactive gas.

29. The polymer packing material as recited in claim 28, wherein said functionalized plurality of surfaces has a plurality of functional groups thereon.

30. The polymer packing material as recited in claim 29, wherein said plurality of functional groups is a sulfonated functional group.

31. The polymer packing material as recited in claim 28, wherein said plurality of surfaces has a plurality of functional groups thereon and a metal oxide coating over said plurality of functional groups.

32. The polymer packing material as recited in claim 31, wherein said metal oxide coating comprises an iron oxide coating.

33. A polymer material having a characteristic water contact angle, wherein the improvement comprises:
a functionalized surface on said polymer material having a modified water contact angle less than said characteristic contact angle.

34. The polymer material as recited in claim 33, wherein said polymer material is polypropylene or polyethylene.

35. The polymer material as recited in claim 33, wherein said polymer material comprises a poly-halogenated polymer.

36. The polymer material as recited in claim 35, wherein said poly-halogenated polymer is selected from the group consisting of poly-n-fluoroethylene, poly-n-fluoropropylene, polyvinylidenedifluoride, polyvinylchloride, and combinations thereof.

37. The polymer material as recited in claim 36, wherein n is selected from the group of mono, di, tri, and tetra.

38. A polymer material comprising at least one functionalized hydrophilic surface.
